(19) United States
(12) Patent Application Publication
(10) Pub. No.: US 2024/0336499 A1
(43) Pub. Date: Oct. 10, 2024

(54) URINE AND WASTEWATER TREATMENT SYSTEM

(71) Applicants: Georgia Tech Research Corporation, Atlanta, GA (US); Cranfield University, Canfield (GB)

(72) Inventors: Shannon YEE, Decatur, GA (US); Kristin RAVNDAL, Cranfield (GB); Chris DAVEY, Cranfield (GB); Ewan MCADAM, Cranfield (GB); Kristine SHERMAN, Smyrna, GA (US); Kyle AZEVEDO, Brookhaven, GA (US); Ryan GAYLO, Canton, GA (US); Travis TURNER, Atlanta, GA (US)

(21) Appl. No.: 18/578,258

(22) PCT Filed: Jul. 15, 2022
(86) PCT No.: PCT/US2022/073816

§ 371 Date: Jan. 10, 2024

Related U.S. Application Data
(60) Provisional application No. 63/222,738, filed on Jul. 16, 2021.

(51) Int. Cl. C02F 1/44; B01D 61/02; B01D 61/14; B01D 61/16; B01D 61/58; C02F 103/00

(52) U.S. Cl. CPC C02F 1/441; B01D 61/025; B01D 61/145; B01D 61/16; B01D 61/58; C02F 1/444; B01D 2311/04; B01D 2311/2523; B01D 2311/2665; B01D 2313/243; B01D 2313/26; B01D 2313/501; B01D 2315/10; C02F 2103/005; C02F 2301/046; C02F 2301/066; C02F 2303/04; C02F 2303/26

(57) ABSTRACT

System and method for a urine and wastewater treatment are described. The urine and wastewater treatment system can include a tank configured to receive liquid waste (102), an air blower (114) configured to blow air into the liquid waste to reduce the density of the liquid waste and to generate crossflow, and a filtration unit comprising an ultra-filtration stage (104) comprising a first permeate outlet and a first concentrate outlet and a reverse osmosis stage (112) comprising a second permeate outlet and a second concentrate outlet. The reverse osmosis stage is configured to receive a first permeate from the ultra-filtration stage.

### CROSS-REFERENCE TO RELATED APPLICATION

This application claims the benefit of and priority to U.S. Provisional Application No. 63/222,738, titled “URINE AND WASTEWATER TREATMENT SYSTEM,” filed on Jul. 16, 2021, the entire contents of which are hereby incorporated herein by reference.

### BACKGROUND

An estimated 4.5 billion people worldwide do not have access to safe, affordable sanitation systems. High levels of child death and disease have been linked to oral fecal contamination where pathogen laden fecal matter enters the food or water supply. Non-sewered sanitation systems are needed where traditional sanitary sewer systems are unavailable or impractical.

### SUMMARY

Disclosed herein is a liquid waste treatment system comprising an ultra-filtration stage and a reverse osmosis stage. The ultra-filtration stage comprises an ultra-filtration filter configured to separate the liquid waste into a first permeate and a first concentrate, and a diffuser positioned at an inlet to the ultra-filtration filter, the diffuser connected to an air blower and configured to introduce air into the liquid waste to reduce the density of the liquid waste and to generate a crossflow within the ultra-filtration filter. The reverse osmosis stage is configured to receive the first permeate from the ultra-filtration stage and separate the first permeate into a second permeate and a second concentrate, the second permeate being a non-potable water for use or re-use. Also disclosed are methods of treating liquid waste using the disclosed liquid waste treatment system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates an example schematic diagram of a urine and wastewater treatment system according to various embodiments described herein.

FIG. 2 illustrates an example method for urine and wastewater treatment according to various embodiments described herein.

FIG. 3 illustrates one example schematic of the urine and wastewater treatment system used as a module within a non-sewered single unit toilet system according to various embodiments described herein.

FIG. 4 illustrates another example schematic of the urine and wastewater treatment system used as a module within a non-sewered single unit toilet system according to various embodiments described herein.

### DETAILED DESCRIPTION

Sanitation systems are needed for regions of the world where open defecation or lack of improved sanitation is common, which can lead to illness. Traditional sewage and wastewater treatment plants which receive waste from sewers can be expensive to implement and operate. Technologies for multi-unit toilets are being developed to process waste on a large scale. However, there is a need for technology to provide access to safe, affordable sanitation systems that can be deployed in a family home without sewer connections. Holistically, as water scarcity rises across the globe, sanitation systems that reduce reliance on large volumes of water for transport of waste over long distances will become increasingly important, not just in developing countries, but globally.

To address these deficiencies, systems for use in a stand-alone non-sewered toilet system are discussed herein. The systems can be configured to inactivate pathogens from human waste and prepare the waste for safe disposal. The systems can also recover valuable resources such as clean water. The systems can be configured to operate without connection to input water or output sewers. Some example systems can be battery based or powered by off-grid renewables. The systems can be optimized for low-cost fabrication and low operation costs. The systems can promote sustainable sanitation services that operate in poor, urban settings, as well as in developed and developing nations.

The ISO 30500 standard provides a technical standard for non-sewered sanitation systems designed to address basic sanitation needs and promote economic, social, and environmental sustainability through strategies that include minimizing water and energy consumption, and converting human excreta to safe output. These sanitation systems are intended to operate without connection to any sewer or drainage network and meet health and environmental safety and regulatory parameters. In some examples, systems described herein can be configured to provide treated output that meets or exceeds the ISO 30500 standard.

For example, human waste streams can include urine, feces, diarrhea, and the like. Sanitation incidentals can include toilet paper, feminine hygiene waste, diapers, other paper products, and the like. In some toilet systems, a portion of sanitation incidentals, including non-organic products such as diapers, can be received and processed separately from the human waste streams. In some examples, the wastes streams comprise human feces and urine, menstrual blood, bile, flushing water, anal cleansing water, toilet paper, other bodily fluids and/or solids. Additionally, the waste streams can comprise water, including flush water, rinse water, wash water, fresh water, consumable water, potable water, useable water, and the like.

For example, a stand-alone non-sewered toilet system can comprise a liquid treatment system and a solids treatment system, each of which can operate as a separate system or be interconnected for treatment of human waste. The stand-alone non-sewered toilet system can also comprise at least one separation system. In some examples, the content of human waste streams can be separated or processed separately. Separation of streams can provide more efficient processing than mixed-content human waste streams by dividing the source material into primarily feces, urine, and wastewater streams. Since 100% separation is not practical, a degree of cross contamination between the streams is acceptable for the subsequent downstream treatment approaches. As described herein, the feces stream, containing primarily feces, is also referred to as the “brown stream.” The brown stream is mostly feces, but can also be mixed with other liquid and solid waste. For example, the brown stream can include feces, toilet paper, some urine, and some water. As described herein, the “green stream” can include mostly water, some urine, and some toilet paper, and usually does not include feces. The green stream is mostly liquid with some solids. As described herein, the urine stream, containing primarily urine, is also referred to as the “yellow stream.” For example, a yellow stream can include urine and some water. As described herein, the wastewater stream is also referred to as the “blue stream.” For example, the blue stream can contain primarily wastewater in the form of flush water, anal rinse water, or excess water that is poured into the toilet. In some examples, the blue stream can also include some urine. Stream separation can enable lower cost and more robust treatment processes given the high degree of variability in low volume fecal deposits (recognized as primarily diarrhea), high volume urine deposits, and excessive amounts of flush and anal rinse water, given future water scarcity constraints.

In the context described above, various examples of systems and methods for urine and wastewater treatment are described herein. The urine and wastewater treatment system can be a liquid treatment system that can operate separately or be configured to integrate with another system. For example, the urine and wastewater treatment system can be a liquid waste treatment system configured for use in a stand-alone non-sewered toilet system. The liquid waste streams can comprise urine, water, and other sanitation incidentals contained in a waste stream collected in a toilet system. In an example, the urine and wastewater treatment system can be integrated as a module for liquid treatment in a stand-alone non-sewered sanitation system. In some examples, the urine and wastewater treatment system can be configured to operate as part of a single unit toilet system. For example, the urine and wastewater treatment system can be integrated for use in a single unit toilet system configured to render the bodily wastes of an adult human into water, CO₂, and mineral ash. In some examples, the urine and wastewater treatment system can be configured to provide treated output that meets or exceeds the ISO 30500 standard.

The urine and wastewater treatment system can be used to process a liquid stream containing mostly urine, or a green stream of human waste. By separating the green stream prior to input into the urine and wastewater treatment system, the system can operate to process the liquids contained therein. In some examples, the green stream can be pre-processed in a separate module or system to clarify the green stream by removing a portion of solids contained in the green stream.

The urine and wastewater treatment system can include a membrane filtration process for the removal of pathogens and chemical contaminants from liquid human waste to produce water suitable for recirculated toilet flushing or safe discharge. The described system can operate as part of a single unit toilet system. The liquid waste, primarily composed of urine, flush water and trace toilet paper, can pass through a series of filtration stages including an ultra-filtration stage and reverse osmosis stage. Each filtration stage can have an associated reservoir tank and pump component enabling each filtration to operate at the most effective pressure. The rejected concentrate can be recirculated through the filtration stages before diversion to a concentration process for discharge. The permeate can be collected and either recirculated to act as flush water in the toilet system or discharged depending on the system requirements. The permeate can meet ISO-30500 reuse or discharge standards. For example, the ISO-30500 reuse standards include chemical oxygen demand (COD)≤50 mg/L, total Nitrogen (N)>70% reduction, total Phosphorus (P)>80% reduction, pH: 6.0-9.0, total suspended solids (TSS)≤10, and E. coli≤100 per L. In another example, discharge standards include chemical oxygen demand (COD)≤150 mg/L, total Nitrogen (N)>70% reduction, total Phosphorus (P)>80% reduction, pH: 6.0-9.0, total suspended solids (TSS)≤30, and E. coli≤100 per L.

In the following discussion, a general description of the urine and wastewater treatment systems and their components is provided, including a discussion of the operation of the same. Non-limiting examples of a urine and wastewater treatment system are discussed. In some examples, the configuration can include optional connections to integrate the urine and wastewater treatment system with other systems comprising a stand-alone non-sewer sanitation system. For example, the urine and wastewater treatment system can integrate with a front-end waste separation system and/or buffer tank system.

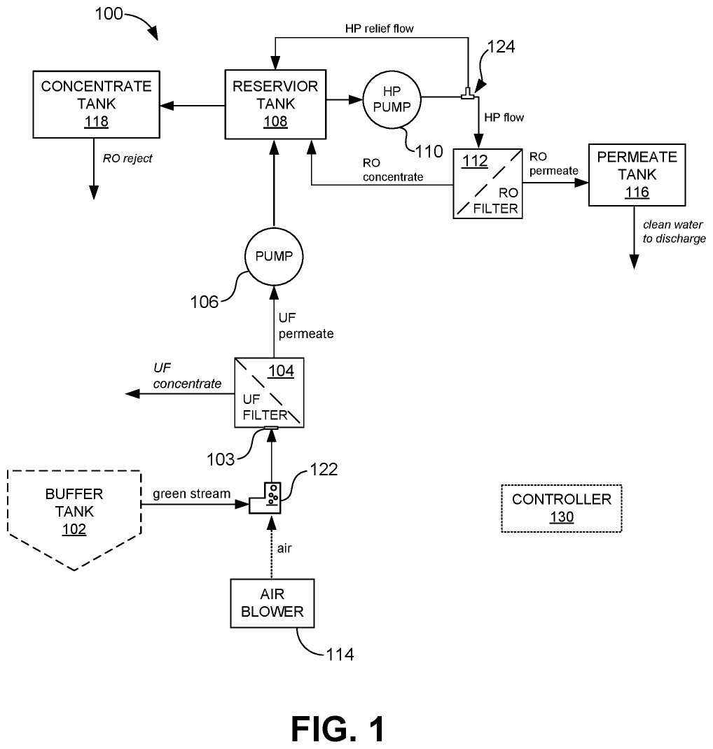

As shown in FIG. 1, the urine and wastewater treatment system 100 can comprise an ultra-filtration (UF) stage comprising an ultra-filtration (UF) membrane filter 104 and a reverse osmosis (RO) stage comprising a reverse osmosis (RO) membrane filter 112. The UF stage can also include a diffuser 122 positioned at an inlet 103 to the UF membrane filter 104, a permeate pump 106, and a reservoir tank 108. An air blower 114 can be connected to the diffuser 122 and configured to introduce air into fluid as it is received into the UF membrane filter 104. The RO stage can also include a high-pressure pump 110 and a permeate tank 116. Additionally, the reservoir tank 108 can receive RO concentrate from the RO stage and a concentrate tank 118 can be in fluid connection with the reservoir tank 108.

A buffer tank 102 can optionally be included in the urine and wastewater treatment system 100 and be configured to receive and hold liquid waste to be treated. Alternatively, the buffer tank 102 can be omitted and an external tank or buffer tank system that receives urine and/or wastewater can serve as the feed for the UF. For example, the urine and wastewater treatment system 100 can be connected to a liquids buffer tank in a buffer tank separation and homogenization system. In an example, the urine containing stream can be a green stream, as described herein, that comprises mostly urine, but can also include water and/or some trace solids, such as toilet paper. In some examples, the green stream can be processed prior to being received by the urine and wastewater treatment system 100. For example, a buffer tank separation and homogenization system can collect and reduce the solids in a human waste stream from a frontend user receptacle or other urine containing streams to clarify the liquid by separating at least a portion of solid particles in a liquids tank. For example, the outlet of liquids tank of the buffer tank separation and homogenization system can be in fluid connection with the to the inlet 103 of the UF filter via a diffuser 122.

The UF membrane filter 104 can be in fluid connection with the buffer tank 102, for example via the diffuser 122. The liquid waste can receive into the UF membrane filter 104 such that an air blower 114 introduces air into the fluid via the diffuser 122 before it passes over the UF membrane filter 104. The fluid mixed with air reduces the density of the liquid waste and displaces the liquid upward, generating crossflow over the UF membrane filter 104 to separate a first permeate stream and a first concentrate stream. For example, the fluid mixed with air reduces the density of the fluid and displaces it upwards generating cross flow through the filter forming the UF permeate. The fluid that does not pass through the filter is the UF concentrate or first concentrate.

A permeate pump 106 can deliver the UF permeate stream, also called the first permeate stream herein, to a reservoir tank 108. The UF concentrate stream, also called a first concentrate stream herein, can be released as an output. For example, the UF concentrate can be delivered to the buffer tank 102. In some examples, if the urine and wastewater treatment system 100 is fluidically connected to a buffer tank separation system, the first concentrate stream can be delivered to the buffer tank separation system.

As shown in FIG. 1, the reservoir tank 108 can receive the first permeate of the UF membrane filter 104 via the permeate pump 106, which are all fluidically connected. A high-pressure pump 110 can transport the fluid from the reservoir tank through a RO membrane filter 112 at a high pressure to separate a second permeate stream and a second concentrate stream. In an example, the second concentrate stream, also called the RO concentrate herein, can be returned to the reservoir tank 108. In some examples, a portion of the second concentrate can be recirculated through the RO membrane filter 112. The majority of the second concentrate stream can be directed to a concentrate tank 118. The second permeate stream, also called the RO permeate herein, can be considered clean and/or usable water. The second permeate stream can be directed to a permeate tank 116 for holding and/or directed for use in a flush tank or discharged to another system or the environment. For example, the second permeate stream can be ISO 30500 compliant to be safely discharged into the environment.

The buffer tank 102, or liquids tank from another system, can be fluidically connected to the UF membrane filter 104 via a conduit such as tubing or other means. The UF membrane filter 104 can operate at a low pressure. For example, the liquid stream between the buffer tank 102 and the UF membrane filter 104 can be a low-pressure stream, having a pressure of about atmospheric pressure or about 1 atm and having a temperature of about 20-40° C. An air pump or air blower 114 can be positioned to introduce air to the fluid flow of the liquid stream at the feed to the UF membrane filter 104. For example, the air blower 114 can diffuse air into the liquid stream using a diffuser 122, such as an air stone. The UF membrane filter 104 can separate fluid received into a first permeate and a first concentrate, where the first permeate is the portion of fluid that passes through the UF membrane filter 104 and the first concentrate is the fluid rejected by the UF membrane filter 104. In some examples, if the urine and wastewater treatment system 100 is fluidically connected to a buffer tank separation system and processed with the other fluids.

A permeate pump 106 can deliver the first permeate to a reservoir tank 108 at a low pressure. A high-pressure pump 110 can be fluidically connected between the reservoir tank 108 and the RO membrane filter 112. The high-pressure pump 110 can be configured to output a fluid at a higher pressure than the intake. For example, the high-pressure pump 110 can pump the first permeate from the reservoir tank at a low pressure, then deliver the fluid to the RO membrane filter 112 at a high pressure. For example, the low pressure can be about 1 bar and the high pressure can be about 30-35 bar. In some examples, a relief valve 124 can be positioned in the high-pressure conduit to return a portion of the pressurized first permeate liquid stream to the reservoir tank 108. The high-pressure pump 110 can deliver the first permeate liquid stream to the RO membrane filter 112 at a high pressure. For example, the high-pressure fluid feed to the RO membrane filter 112 can be about 435 psi and having a temperature of about 20-40° C. The RO membrane filter 112 can separate fluid received into a second permeate and a second concentrate, where the second permeate is the portion of fluid that passes through the RO membrane filter 112 and the second concentrate is the fluid rejected by the RO membrane filter 112. The RO membrane filter 112 can be fluidically connected to a permeate tank 116 configured to receive the second permeate. The RO membrane filter 112 can be fluidically connected to a concentrate tank 118 configured to receive the second concentrate. The second permeate stream can be directed to a permeate tank 116 for holding and/or directed for use in a flush tank or discharged to another system or the environment. For example, the second permeate stream can be ISO 30500 compliant to be safely discharged into the environment. The second concentrate stream can be returned to the reservoir tank 108 and a portion can be recirculated by the high-pressure pump 110 through the RO membrane filter 112.

The concentrate tank 118 can hold the RO concentrate delivered from the reservoir tank 108. At least a portion of the collected RO concentrate, also called RO reject herein, can be released to another system for further processing. For example, the RO reject can be delivered to another system, such as a solids treatment system, for a concentration process for discharge. The RO concentrate can comprise solids and/or salts filtered from the liquid stream of the urine and wastewater treatment system 100. In some examples, the RO reject can be received into a concentrator (not shown) of a solids treatment system. For example, a concentrator can be configured to receive a liquid waste that can be heated. In an example, the RO reject from the urine and wastewater treatment system 100 can be received into the concentrator. Humidified air and/or an off gas can be released, and a concentrated output can be delivered to another system for further treatment or discharged from the system. The humidified air and/or off gas can be delivered to a main exhaust outlet and filtered before being released into the atmosphere. The gas filter in the main exhaust outlet can be configured such that the gas released is ISO 30500 compliant.

The buffer tank 102, the reservoir tank 108, the permeate tank 116, and the concentrate tank 118 can each have a vent outlet to release air or any gas in the respective tanks (not shown). Each of the vent outlets can be connected to a main gas exhaust line with a gas filter. For example, when the urine and wastewater treatment system 100 is a module in a single unit toilet system, the main exhaust line can also receive gas vented from other modules of the single unit toilet system. The gas filter can be configured so that the filtered gas release from the system is ISO 30500 compliant.

The urine and wastewater treatment system 100 can also comprise additional valves, sensors, switches, actuators, pumps, and the like to facilitate the operation of the urine and wastewater treatment system 100. For example, the buffer tank 102, the reservoir tank 108, the permeate tank 116, and/or the concentrate tank 118 can have sensors to detect the level of fluid in the respective tank. The urine and wastewater treatment system 100 can also comprise a controller 130. The controller 130 can be configured to interface with the valves, pumps, sensors, switches, and/or actuators in the system. For example, the controller 130 can be configured to operate the valves and/or pumps in response to a sensor indication from a tank, where the tank may have one or more sensors to indicate the level of the fluid within the tank. The controller 130 can be configured to control only the operation of the components of the urine and wastewater treatment system 100. In some examples, the controller can be integrated in a control system for a single unit toilet system in which the urine and wastewater treatment system 100 resides as a module.

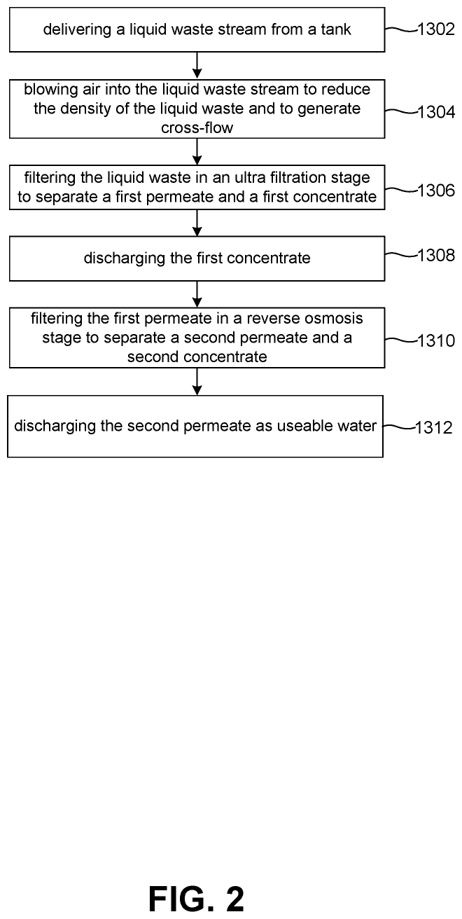

FIG. 2 shows an example method for collection and separation of human waste as described herein. At box 1302, the method can include receiving a liquid waste from a tank. For example, the liquid waste can be received from a buffer tank. In some examples, the liquid waste can be urine and/or wastewater. For example, the liquid waste can be a clarified green stream, as described herein, comprising urine, water, and/or some trace toilet paper after at least a portion of solids have been removed. In some examples, the buffer tank that is external to the urine and wastewater treatment system 100.

At box 1304, the method can include blowing air into the liquid waste stream to reduce the density of the liquid waste and to generate crossflow. For example, as discussed with respect to FIG. 1, the air pump or air blower can be positioned to introduce air to the fluid flow of the liquid stream at the feed to the UF membrane. For example, the air blower can diffuse air into the liquid stream using an air stone causing a bubbling effect. In another example, the air can be introduced by another distribution method.

At box 1306, the method can include filtering the liquid waste stream in an ultra-filtration stage to separate a first permeate and a first concentrate. The fluid can be filtered using an ultra-filtration membrane to separate a first permeate and a first concentrate. The fluid from the buffer tank and air mixing reduces the density of the fluid and displaces it upwards generating cross flow through the filter forming the first permeate.

At box 1308, the method can include discharging the first concentrate. The first concentrate from the UF membrane filter can contain some solids. The first concentrate can be discharged and/or returned to a pre-processing system for separation of solid waste in concentrate. For example, the concentrate can be returned to the same system that pre-processed green stream to clarify the green stream, then clarified and recirculated in the urine and wastewater treatment system. The first permeate, most of solids removed, can be directed to a next stage of filtering. For example, the first permeate can be pumped to a reservoir tank.

At box 1310, the method can include filtering the first permeate in a reverse osmosis stage to separate a second permeate and a second concentrate. The reverse osmosis stage can operate at a high pressure. For example, the first permeate can be delivered to a reverse osmosis membrane filter via a high-pressure pump. The first permeate can be filtered in the reverse osmosis membrane filter to separate a second permeate and a second concentrate. At box 1312, the method can include discharging the second permeate. In some examples, the second permeate can be reused. In some examples, the second permeate can be ISO 30500 compliant. Techniques for measuring chemical oxygen demand (COD), total nitrogen (total N), total phosphorus (total P), pH, total suspended solids (TSS), and E. coli (colony forming units or CFUs) are provided in the Examples.

As can be understood, the example method can be carried out in the order recited or in any other order that is logically possible. The method can omit steps or include additional steps. For example, the method can include a cleaning cycle. The cleaning cycle can include a backflow or pumping of a cleaning fluid through the system. In some examples, the method can be implemented automatically by the controller 130 based on sensor values, state of operation, user input, or other factors.

For example, the controller 130 can interface with sensors, valves, pumps, and motors of the urine and wastewater treatment system 100. The controller 130 can comprise at least a processor and memory. The controller can be configured to implement a sequence of instructions to operate the sensors, valves, pumps, and motors based on the state of operation of the UF membrane filter 104 and/or the RO membrane filter 112. For example, the controller 130 can detect a level of fluid in each of the buffer tank 102, reservoir tank 108, permeate tank 116, and concentrate tank 118 via sensors in each of the respective tanks. For example, the controller 130 can actuate valves to empty said tanks and/or operate pumps to deliver fluids from said tanks. For example, the controller 130 can implement instructions for an RO flush cycle by turning off the high-pressure pump 110, closing an RO inlet valve, and draining the reservoir tank 108. After a time to drain the reservoir tank 108 to the concentrate tank 118, open the RO flush valve, turn on the high-pressure pump 110 and run the flush cycle for a predetermined time. For example, the liquid waste can be filtered by using a sensor to detect that the buffer tank 102 is full, the reservoir tank 108 is not full, and the RO flush cycle is complete. The controller 130 can implement instructions to start the UF sequence by turning on the air blower 114 and turning on the permeate pump 106 to filter the liquid waste pumped from the buffer tank 102. After a time has elapsed, the permeate pump 106 and air blower 114 can be turned off, then the concentrate can be drained from the UF membrane filter 104.

The urine and wastewater treatment system 100 can be configured for use in various systems and applications. As discussed above, as an example, the urine and wastewater treatment system 100 can be a liquids treatment system configured for use in a stand-alone non-sewered toilet system. The urine and wastewater treatment system 100 can be configured to operate as part of and integrate with a single unit toilet system, including such systems as a solids treatment system and/or a separation system.

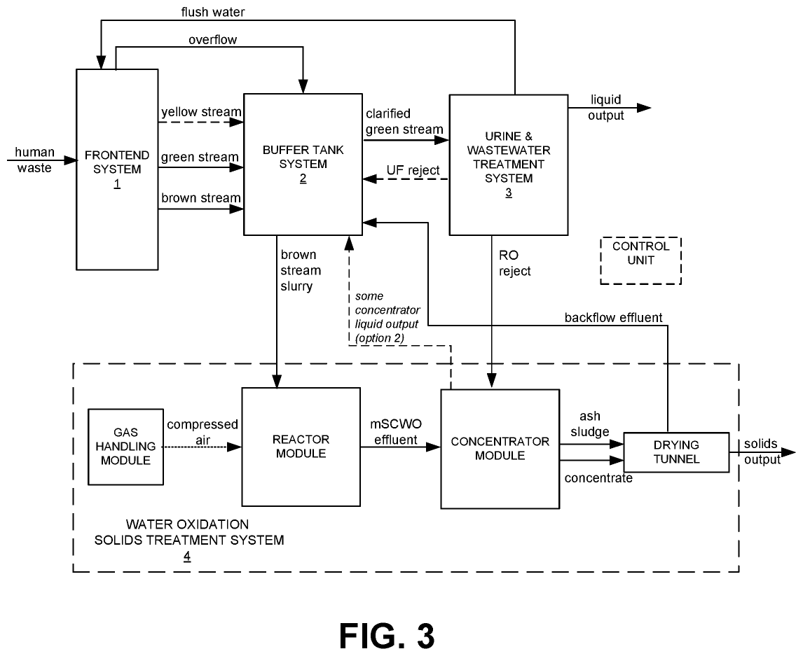

FIG. 3 illustrates an example schematic of a non-sewered single unit toilet system that includes a frontend system 1, a buffer tank system 2, a urine and wastewater system 3, and a water oxidation solids treatment system 4. In this example, the urine and wastewater treatment system 3 can comprise the urine and wastewater treatment system 100 described herein. In this example, the frontend system 1 can be configured to capture human waste and to separate the mixed waste stream into at least one of a green stream and a brown stream. In some examples, a yellow stream can also be separated. The separated green, brown, and/or yellow streams can be further processed by a buffer tank system 2. The buffer tank system 2 can be configured to output a clarified green stream to a urine and wastewater treatment system 3 and a brown stream slurry to the water oxidation solids treatment system 4. Further, the buffer tank system 2 can receive input from one or more of the systems or modules of the single unit toilet system for additional processing. The non-sewered toilet system can be configured to deliver a treated liquid output and a treated solids output. Clean water and/or treated water can be further used in the system for flush water in the frontend system 1 or used for processing in one or more of the systems or modules. The single unit toilet system can further comprise control unit comprising at least one controller for the operation of the system and/or one or more modules of the system, including valves, pumps, motors, sensors, and other devices.

As shown in the example system of FIG. 3, the urine and wastewater treatment system 3 can deliver the RO reject to the concentrator module of the water oxidation solids treatment system 4. For example, the RO reject can comprise solids and/or salts filtered from the liquid waste of the urine and wastewater treatment system 3. The RO reject can be received into the concentrator module and heated to evaporate at least some of the liquid content. Pressurized air can be introduced into the concentrator such that humidified air and/or an off gas is released, and the concentrated output can be delivered to another system or released to remove remaining solids from the system. In some examples, the urine and wastewater treatment system 3 can optionally include a concentrator or concentrator module that comprises a concentrator tank and a heater.

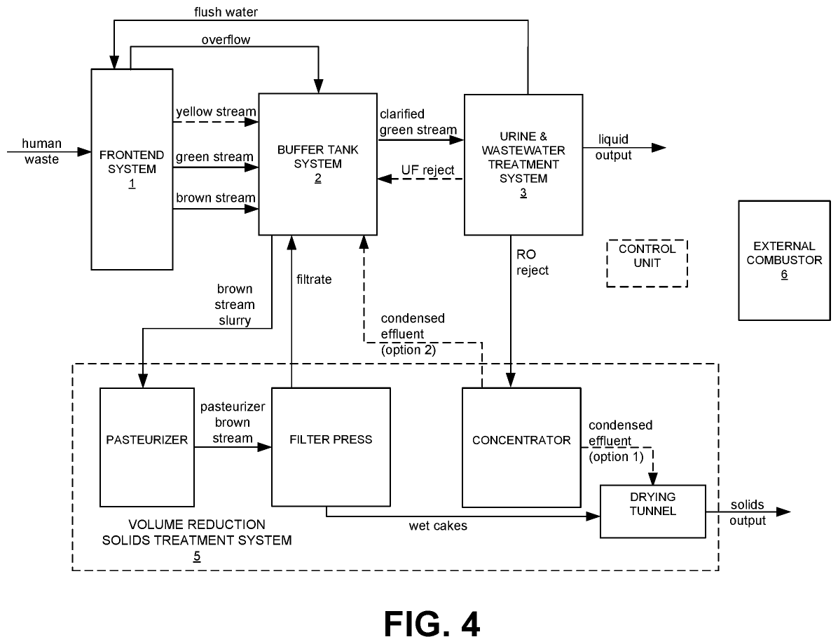

FIG. 4 illustrates another example schematic of a non-sewered single unit toilet system that includes a frontend system 1, a buffer tank system 2, a urine and wastewater system 3, a volume reduction solids treatment system 5, and external combustor 6. In this example, a urine and wastewater treatment system 3 can comprise the urine and wastewater treatment system 100 described herein. As shown the urine and wastewater treatment system 3 can be modular to adapt to another configuration of non-sewered single unit toilet system. Although there are similar modules in both FIG. 3 and FIG. 4, a different solids treatment system is shown in FIG. 8 as a volume reduction system 5. Similar to FIG. 3, the frontend system 1 is configured to capture the human waste and to separate the mixed waste stream into at least one of a green stream and a brown stream. In some examples, a yellow stream can also be separated. The separated green, brown, and/or yellow streams can be further processed by a buffer tank system 2. The buffer tank system 2 can be configured to output a clarified green stream to a urine and wastewater treatment system 3 and a brown stream slurry to the volume reduction solids treatment system 5. The single unit toilet system can be configured to deliver a treated liquids output and a treated solids output. The single unit toilet system can further comprise a control unit comprising at least one controller for the operation of the system and/or one or more modules of the system, including valves, pumps, motors, sensors, and other devices. In this example, an external combustor 6 can also be part of the non-sewered single unit toilet system can be configured to receive the treated solids output.

As shown in the example system of FIG. 4, the urine and wastewater treatment system 3 can deliver the RO reject to the concentrator module of the volume reduction solids treatment system 4. For example, volume reduction feces treatment system 5 can be configured with a concentrator configured to receive the RO reject to be heated. In an example, a RO rejection from a concentrate tank of the urine and wastewater treatment system 3 can be received into the concentrator and heated to evaporate at least some of the liquid content. Humidified air and/or off gases can be released, and the concentrated output can be delivered to another system or released to remove remaining solids from the system.

The features of the embodiments described herein are representative and, in alternative embodiments, certain features and elements can be added or omitted. It is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

### ASPECTS

The following list of exemplary aspects supports and is supported by the disclosure provided herein.

Aspect 1. A liquid waste treatment system, the system comprising:
an ultra-filtration stage comprising:
an ultra-filtration filter configured to separate the liquid waste into a first permeate and a first concentrate, and
a diffuser positioned at an inlet to the ultra-filtration filter, the diffuser connected to an air blower and configured to introduce air into the liquid waste to reduce the density of the liquid waste and to generate a crossflow within the ultra-filtration filter; and
a reverse osmosis stage configured to receive the first permeate from the ultra-filtration stage and separate the first permeate into a second permeate and a second concentrate, the second permeate being a non-potable water for use or re-use.

Aspect 2. The liquid waste treatment system of aspect 1, wherein:
the ultra-filtration stage comprises a reservoir tank and a permeate pump;
the reverse osmosis stage comprises a permeate tank and a high pressure pump.

Aspect 3. The liquid waste treatment system of aspect 2, wherein the reverse osmosis stage further comprises a recirculation conduit configured to deliver the second concentrate from the reservoir tank.

Aspect 4. The liquid waste treatment system of any one of aspects 1-3, wherein the liquid waste comprises at least one of urine, feces, rinse water, trace feces, and trace toilet incidentals.

Aspect 5. The liquid waste treatment system of any one of aspects 1-4, wherein the liquid waste is a clarified liquid received from a buffer tank system.

Aspect 6. The liquid waste treatment system of any one of aspects 1-5, wherein the second permeate discharged as non-potable water for use or re-use meets at least one of:
chemical oxygen demand (COD)≤50 mg/L;
total suspended solids (TSS)≤10 mg/L;
total Nitrogen (N)>70% reduction relative to the total N in the liquid waste received into the UF stage;
total Phosphorus (P)>80% reduction relative to the total P in the liquid waste received into the UF stage; and
E. coli≤100 per L.

Aspect 7. The liquid waste treatment system of any one of aspects 1-6, wherein the ultra-filtration stage operates at a first pressure and the reverse osmosis stages operate at a second pressure.

Aspect 8. The liquid waste treatment system of any one of aspects 1-7, wherein the reverse osmosis stage operates a high pressure.

Aspect 9. The liquid waste treatment system of any one of aspects 1-8, wherein the diffuser comprises an air stone.

Aspect 10. The liquid waste treatment system of any one of aspects 1-9, wherein a controller enables automated operation of the ultra-filtration stage and the reverse osmosis stage.

Aspect 11. A method for treatment of liquid waste, the method comprising:
blowing air into the liquid waste to reduce the density of the liquid waste and to generate crossflow;
filtering the liquid waste in an ultra-filtration stage to separate a first permeate and a first concentrate;
discharging the first concentrate;
filtering the first permeate in a reverse osmosis stage to separate a second permeate and a second concentrate;
discharging the second permeate as useable water.

Aspect 12. The method of aspect 11, further comprising pumping the first permeate to a reservoir tank.

Aspect 13. The method of aspect 11 or 12, further comprising pumping the first permeate from the reservoir tank through the reverse osmosis stage at a high pressure.

Aspect 14. The method of any one of aspects 11-13, further comprising recirculating the second concentrate to filter in the reverse osmosis stage.

Aspect 15. The method of any one of aspects 11-14, wherein the second permeate that is discharged as useable water meets at least one of:
chemical oxygen demand (COD)≤50 mg/L;
total suspended solids (TSS)≤10 mg/L;
total Nitrogen (N)>70% reduction relative to the total N in the liquid waste received into the UF stage;
total Phosphorus (P)>80% reduction relative to the total P in the liquid waste received into the UF stage; and
E. coli≤100 per L.

Aspect 16. The method of any one of aspects 11-15, wherein the liquid waste comprises at least one of urine, feces, rinse water, trace feces, and trace toilet incidentals.

Aspect 17. The method of any one of aspects 11-16, wherein the liquid waste is a clarified liquid received from a buffer tank system.

Aspect 18. The method of any one of aspects 11-17, wherein discharging the first concentrate comprises discharging the first concentrate to a system for separation of solid waste in concentrate.

Aspect 19. The method of any one of aspects 11-18, wherein filtering the first permeate in the reverse osmosis stage comprises receiving the first permeate in a reservoir tank and recirculating the second concentrate.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Samples of the liquid output of the urine and wastewater treatment system were tested to measure chemical oxygen demand (COD), total nitrogen (total N), total phosphorus (total P), pH, total suspended solids (TSS), and E. coli (colony forming units or CFUs). Examples of tested liquid output parameters compared to the ISO 30500 standard are shown in TABLE 1. Exemplary methods for testing the liquid output parameters are provided in the Test Protocols below.

TABLE 1

| | ISO 30500 | | | | | | |
|---|---|---|---|---|---|---|---|
| | liquid effluent | Exemplary UWW System 1 | | | Exemplary UWW System 2 | | |
| | performance | | | number of | | | number of |
| parameter | threshold | range | average | samples | range | average | samples |
| COD | Category A¹ | 20-404 mg/L | 87 mg/L | 18 | 24-38 mg/L | 33 mg/L | 3 |
| | ≤50 mg/L | | | | | | |
| | Category B² | | | | | | |
| | ≤150 mg/L | | | | | | |
| Total N | >70% | 71.8-98.7% | 86.7% | 17 | 77.8-97.9% | 86.5% | 7 |
| | reduction | reduction | reduction | | reduction³ | reduction | |
| Total P | >80% | 99.7-100% | 99.9% | 17 | 99.8-100% | 99.9% | 7 |
| | reduction | reduction | reduction | | reduction | reduction | |
| pH | 6.0-9.0 | 9.05-10.14 | 9.70 | 18 | 8.94-9.92 | 9.46 | 6 |
| TSS | Category A | below | — | 18 | below | — | 4 |
| | ≤10 mg/L | detection- | | | detection- | | |
| | Category B | 34 mg/L | | | 1 mg/L | | |
| | ≤30 mg/L | | | | | | |
| E. coli | ≤100 per L | below | — | 11 | below | — | 5 |
| | | detection | | | detection | | |

¹Per ISO 30500: “Category A usage refers to unrestricted urban uses that comprise all uses where public access is not restricted (e.g. landscape irrigation, toilet flushing).”
²Per ISO 30500: “Category B usage refers to discharge into surface water and other restricted urban uses that comprise all uses where public access is controlled or restricted by physical or institutional barrier (e.g. fences, temporal access restriction).”
³% reductions are measured relative to the concentrations of liquid influent to the Urine and Wastewater Treatment System (i.e., immediately prior to the ultrafiltration stage).

### Test Protocols

Chemical Oxygen Demand Test Protocol: The chemical oxygen demand (COD) is measured for samples taken using the Urine and Wastewater Treatment System Sampling Procedure as described herein. Chemical oxygen demand can be measured by any method known in the art such as, for example, using a USEPA Reactor Digestion Method kit manufactured by HACH® Company (Loveland, CO, USA). Spectrophotometers and colorimeters DR 6000, DR 5000, DR 3900, DR 3800, DR 2800, DR 2700, DR 1900, and DR 900 from HACH® Company are suitable for performing this test although COD can also be performed on UV-Vis spectrophotometers and/or colorimeters from other manufacturers. For the listed instruments, the test is performed as follows:

Samples can be collected in clean glass bottles and/or plastic containers free of organic contamination. Samples are tested as quickly as possible after collection.

For analyzing a typical sample, a reactor is initialized and preheated to 150° C. A DRB 200 reactor from HACH® Company is used herein; however, any suitable reactor can be used by following manufacturer-provided protocols. Different sample vials containing pre-packaged reagents are obtained from HACH® Company based on the expected COD, with wider and narrower detection limits available. The ordinarily-skilled artisan will be able to choose the appropriate vials and reagents based on expected COD of the sample to be measured as well as previous test results.

2 mL of sample is added to a typical vial containing digestion reagents, or for detection in the 250-15,000 mg/L range, 0.20 mL of sample is added to the vial using a micropipette. A second vial is prepared as a blank using deionized water. Both the sample and the blank are externally rinsed and wiped with a paper towel or lint-free wipe to dry. Vials are inverted to mix and placed in the reactor, where they are heated for 2 hours. The reactor is turned off and the vials are allowed to cool for 20 minutes or until the temperature reaches 120° C. Vials are inverted several times and placed in a rack to cool.

The blank vial is externally cleaned and placed into the colorimeter or spectrophotometer. A zero reading is taken. The prepared sample vial is externally cleaned and placed into the colorimeter or spectrophotometer and a COD reading is taken. The blank can be used for several sample vials in the same lot of reagent vials and only requires replacement if absorbance changes by at least 0.01 absorbance units over time.

If desired, instrumental accuracy is verified using a series of standard solutions of known concentration. Factory calibration of the instrument can be adjusted to reflect known values of the standard solutions.

Total Nitrogen Test Protocol: The total nitrogen (total N) is measured for samples taken using the Urine and Wastewater Treatment System Sampling Procedure as described herein. Total nitrogen can be measured by any method known in the art such as, for example, using a Persulfate Digestion Method kit manufactured by HACH® Company (Loveland, CO, USA). Spectrophotometers and colorimeters DR 6000, DR 5000, DR 3900, DR 3800, DR 2800, DR 2700, DR 1900, and DR 900 from HACH® Company are suitable for performing this test although total nitrogen detection can also be performed on UV-Vis spectrophotometers and/or colorimeters from other manufacturers. For the listed instruments, the test is performed as follows:

Samples are tested as quickly as possible after collection. For analyzing a typical sample, a reactor is initialized and preheated to 105° C. A DRB 200 reactor from HACH® Company is used herein; however, any suitable reactor can be used by following manufacturer-provided protocols. Nitrogen Hydroxide Digestion Reagent vials from HACH® Company are used herein; these contain pre-measured reagents useful for testing total nitrogen. The contents of one pre-measured packet of nitrogen persulfate are added to a first reagent vial for use in measuring a sample, and to a second reagent vial for use in measuring a blank. 0.5 mL of sample is added to one vial and 0.5 mL of deionized water is used to the second vial. Deionized water must be free of all nitrogen-containing species. The vials are capped and shaken vigorously for 30 seconds. The shaken vials are placed in the reactor for 30 minutes. Following reaction, the vials are removed from the reactor and allowed to cool to room temperature.

Pre-measured packets of Total Nitrogen Reagent A provided by HACH® Company are added to the sample and blank vials. The vials are capped and shaken for 30 seconds, then reacted for 3 minutes. After 3 minutes, the caps are removed from the vials and pre-measured packets of Total Nitrogen Reagent B provided by HACH® Company are added to the vials. The vials are capped and shaken for 15 seconds, then reacted for 2 minutes. Following reaction, 2 mL of the digested samples from the vials are added to separate Total Nitrogen Reagent C vials provided by HACH® company. A similar procedure is followed for deionized water blanks. The reagent vials are capped and inverted slowly 10 times to mix. After 5 minutes, the vials are cleaned externally and measured using a spectrophotometer or colorimeter.

Blanks can be saved for up to 7 days if kept in the dark at room temperature. When suspended solids appear in the blanks, they should be discarded and new blanks prepared. This procedure is effective at detecting at least 95% of nitrogen in ammonium chloride, ammonium sulfate, ammonium acetate, glycine, urea, and other organic nitrogen species.

If desired, instrumental accuracy is verified using standard additions to spike a fresh sample, or using a series of standard solutions of known concentration. Instrumental accuracy across different sources of nitrogen can be verified by preparing stock solutions using known amounts of different nitrogen species (e.g. ammonia, glycine, nicotinic acid-p-toluenesulfonic acid, or the like).

Total Phosphorus Test Protocol: The total phosphorus (total P) is measured for samples taken using the Urine and Wastewater Treatment System Sampling Procedure as described herein. Total phosphorus can be measured by any method known in the art such as, for example, using a USEPA PhosVer® 3 with Acid Persulfate Digestion Method kit manufactured by HACH® Company (Loveland, CO, USA). Spectrophotometers and colorimeters DR 6000, DR 5000, DR 3900, DR 3800, DR 2800, DR 2700, DR 1900, and DR 900 from HACH® Company are suitable for performing this test although total phosphorus detection can also be performed on UV-Vis spectrophotometers and/or colorimeters from other manufacturers. For the listed instruments, the test is performed as follows:

Samples are tested as quickly as possible after collection. When samples are processed, pH should be adjusted to 7 using 5.0 N sodium hydroxide. Volume additions at any stage in the process (e.g. acidification, pH adjustment) should be corrected for when interpreting test results.

For analyzing a typical sample, a reactor is initialized and preheated to 150° C. A DRB 200 reactor from HACH® Company is used herein; however, any suitable reactor can be used by following manufacturer-provided protocols. 5.0 mL of sample to be tested is added to a vial, followed by a pre-measured amount of potassium persulfate provided as part of a test kit available from HACH® Company. The sample is shaken to dissolve any powder and the sample vial is inserted into the reactor and allowed to react for 30 minutes. This reaction converts organic and condensed inorganic phosphates to reactive orthophosphate. The sample vial is removed from the reactor and allowed to cool to room temperature. 2 mL of 1.54 N sodium hydroxide is added to the sample vial and the vial is capped and inverted to mix. The vial is wiped with a lint-free cloth or wipe to clean and dry the outer surface of the vial, and the vial is then inserted into a cell holder in the spectrophotometer or colorimeter. The spectrophotometer or colorimeter is zeroed and a pre-measured amount of molybdate and ascorbic acid (herein, from a PhosVer® 3 powder pillow available from HACH® company) is added to the vial. The vial is shaken for 20-30 seconds to disperse the powder, which does not dissolve completely. After a 2-minute reaction time, orthophosphate in the sample has reacted with molybdate to produce a mixed complex having an intense blue color. The vial is again wiped with a lint-free cloth or wipe and inserted into the spectrophotometer or colorimeter and a total phosphorus reading is taken using absorbance at 880 nm for spectrophotometers or 610 nm for colorimeters (for a reduced phosphate/molybdate complex).

In a typical test, range for total phosphorus is from 0.06 to 3.5 mg/L PO₄³⁻. Samples showing a higher concentration should be diluted and re-tested for accuracy of reporting. If desired, instrumental accuracy is verified using standard additions to spike a fresh sample, or using a series of standard solutions of known concentration.

Total Suspended Solids Test Protocol: The total suspended solids (TSS) are measured for samples taken using the Urine and Wastewater Treatment System Sampling Procedure as described herein. Total suspended solids can be measured using any technique known in the art such as, for example, the test for Residue, Non-Filterable (Gravimetric, Dried at 103-105° C.) protocol from the US EPA National Exposure Research Laboratory. This method is useful for determining from about 4 mg/L to about 20,000 mg/L of suspended solids.

Briefly, a glass fiber filter is placed into a membrane filter apparatus. A vacuum is applied and the filter is washed with at least three 20 mL volumes of distilled water. Vacuum is applied until all traces of water are removed. The filter is dried in an oven at 103-105° C. for one hour and stored in a desiccator until needed. The filter is weighed immediately before use and handled with forceps or tongs only.

Sample volume is selected such that at least 1.0 mg of residue remains on the filter for a 4.7 cm filter. For other filter diameters, the ordinarily-skilled artisan will be able to select a sample volume equal to about 7 mL/cm² of filter area and collect a weight of residue proportional to 1.0 mg.

The filter is weighed and placed in the filtering apparatus. Suction is applied. The filter is wetted with a small volume of distilled water. The sample is shaken vigorously and the preselected sample volume is applied to the filter using an appropriate means for the volume selected (e.g. graduated cylinder). Suction continues until all traces of water are removed. The graduated cylinder or other apparatus is washed with distilled water three times and the washes are applied to the filter. The filter, non-filterable residue, and filter apparatus are further washed with distilled water three times and all traces of water are again removed. The filter is removed from the filter apparatus and dried for at least one hour at 103-105° C. The filter is allowed to cool in a desiccator and is weighed. The drying cycle is repeated until a constant weight is obtained.

pH Test Protocol: The pH is measured for samples taken using as described herein. A probe from a calibrated digital pH meter or water quality meter with pH measurement capability is immersed in the sample and pH value is displayed on a screen on the meter. Various pH meters and/or water quality meters can be used including the Myron L Ultrameter II CPFC^{E} water quality meter available from the MYRON L® Company (Carlsbad, CA, USA).

E. coli Detection Test Protocol: E. coli (colony forming units or CFUs) is measured for samples taken using the Urine and Wastewater Treatment System Sampling Procedure as described herein. E. coli CFUs can be measured by any technique known in the art. Herein, a PETRIFILM™ E. coli/coliform count plate from 3M™ Company (St. Paul, MN, US) was used. The PETRIFILM™ plate contains modified violet red bile (VRB) nutrients, a cold-water soluble gelling agent, 5-bromo-4-chloro-3-indolyl-D-glucuronide (BCIG, an indicator of glucuronidase activity), and a tetrazolium indicator for facilitating colony enumeration.

The sample is blended or homogenized with an appropriate sterile diluent such as Butterfield's phosphate buffered dilution water, 0.1% peptone water, peptone salt diluent, quarter-strength Ringer's solution, 0.85-0.90% saline solution, bisulfite-free letheen broth, or distilled water.

The PETRIFILM™ plate is placed on a flat surface. A top film on the plate is lifted. 1 mL of sample suspension is dispensed on the center of the plate's bottom film, using a pipette held perpendicular to the inoculation area. The top film is rolled down onto the sample without trapping air bubbles. A 3M™ PETRIFILM™ Spreader is used to spread the inoculum over the entire plate growth area. The spreader is removed and the plate is left undisturbed for at least one minute, allowing a gel to form.

Following gel formation, the plate is incubated horizontally in a stack of no more than 20 plates. Incubation time can vary and the ordinarily-skilled artisan can select an incubation time appropriate to a given application based on instructions supplied by the manufacturer. Following incubation, colonies on the plates can be counted using a standard colony counter or another illuminated magnifier. Colonies appearing as blue to red-blue and associated with entrapped gas are to be counted as confirmed E. coli. Colonies should be counted within 1 hour of removal from the incubator or may be stored at −15° C. for up to one week prior to counting.

For extremely dense plates following incubation, the original sample may need to be diluted in order to obtain an accurate count, with appropriate volume corrections made based on the dilution volume.

### Sampling Procedures

Using the Test Protocols described above, various properties of the output of system components, such as water, liquids components, and the like can be characterized using samples prepared with the following sampling procedure.

Urine and Wastewater Treatment System Sampling Procedure: Any suitable extraction device can be used to obtain a liquid sample from the urine and wastewater treatment system. For example, a syringe or volumetric pipette can be used to withdraw a specific volume of material, which may contain liquids and/or suspended solids, from the urine and wastewater treatment system. Alternatively, a greater volume of material than required by for analysis can be withdrawn into a sterile container and volume for testing can be measured separately. In an alternative aspect, a valve can be opened, allowing free flow of the liquid sample into a collection container. Samples collected in this manner can be used in any of the test protocols described herein.

1. A liquid waste treatment system, the system comprising:
an ultra-filtration stage comprising:
an ultra-filtration filter configured to separate the liquid waste into a first permeate and a first concentrate, and
a diffuser positioned at an inlet to the ultra-filtration filter, the diffuser connected to an air blower and configured to introduce air into the liquid waste to reduce the density of the liquid waste and to generate a crossflow within the ultra-filtration filter; and
a reverse osmosis stage configured to receive the first permeate from the ultra-filtration stage and separate the first permeate into a second permeate and a second concentrate, the second permeate being a non-potable water for use or re-use.

2. The liquid waste treatment system of claim 1, wherein:
the ultra-filtration stage comprises a reservoir tank and a permeate pump;
the reverse osmosis stage comprises a permeate tank and a high-pressure pump.

3. The liquid waste treatment system of claim 2, wherein the reverse osmosis stage further comprises a recirculation conduit configured to deliver the second concentrate to the reservoir tank.

4. The liquid waste treatment system of claim 1, wherein the liquid waste comprises at least one of urine, feces, rinse water, and trace toilet incidentals.

5. The liquid waste treatment system of claim 1, wherein the liquid waste is a clarified liquid received from a buffer tank system.

6. The liquid waste treatment system of claim 1, wherein the second permeate discharged as non-potable water for use or re-use meets at least one of:
chemical oxygen demand (COD)≤50 mg/L;
total suspended solids (TSS)≤10 mg/L;
total Nitrogen (N)>70% reduction relative to the total N in the liquid waste received into the ultra-filtration stage;
total Phosphorus (P)>80% reduction relative to the total P in the liquid waste received into the ultra-filtration stage; and
E. coli≤100 per L.

7. The liquid waste treatment system of claim 1, wherein the ultra-filtration stage operates at a first pressure and the reverse osmosis stages operate at a second pressure.

8. The liquid waste treatment system of claim 1, wherein the reverse osmosis stage operates at a high pressure.

9. The liquid waste treatment system of claim 1, wherein the diffuser comprises an air stone.

10. The liquid waste treatment system of claim 1, wherein a controller enables automated operation of the ultra-filtration stage and the reverse osmosis stage.

11. A method for treatment of liquid waste, the method comprising:
blowing air into a liquid waste to reduce the density of the liquid waste and to generate crossflow;
filtering the liquid waste in an ultra-filtration stage to separate a first permeate and a first concentrate;
discharging the first concentrate;
filtering the first permeate in a reverse osmosis stage to separate a second permeate and a second concentrate; and
discharging the second permeate as a useable water.

12. The method of claim 11, further comprising pumping the first permeate to a reservoir tank.

13. The method of claim 11, further comprising pumping the first permeate from the reservoir tank through the reverse osmosis stage at a high pressure.

14. The method of claim 11, further comprising recirculating the second concentrate to filter in the reverse osmosis stage.

15. The method of claim 11, wherein the second permeate that is discharged as useable water meets at least one of:
chemical oxygen demand (COD)≤50 mg/L;
total suspended solids (TSS)≤10 mg/L;
total Nitrogen (N)>70% reduction relative to the total N in the liquid waste received into the ultra-filtration stage;
total Phosphorus (P)>80% reduction relative to the total P in the liquid waste received into the ultra-filtration stage; and
E. coli≤100 per L.

16. The method of claim 11, wherein the liquid waste comprises at least one of urine, feces, rinse water, and trace toilet incidentals.

17. The method of claim 11, wherein the liquid waste is a clarified liquid received from a buffer tank system.

18. The method of claim 11, wherein discharging the first concentrate comprises discharging the first concentrate to a system for separation of solid waste in concentrate.

19. The method of claim 11, wherein filtering the first permeate in the reverse osmosis stage comprises receiving the first permeate in a reservoir tank and recirculating the second concentrate.
